(19) United States
(12) Patent Application Publication
(10) Pub. No.: US 2019/0331493 A1
(43) Pub. Date: Oct. 31, 2019

(54) Asynchronous SDI

(71) Applicant: XSENS HOLDING B.V., Enschede (NL)

(72) Inventors: Giovanni Bellusci, Enschede (NL); Sanjay Bhandari, Cupertino, CA (US); Raymond Zandbergen, Enschede (NL); Matteo Giuberti, The Netherlands (NL); Laurens Slot, Enschede (NL)

(73) Assignee: XSENS HOLDING B.V., Enschede (NL)

(21) Appl. No.: 15/962,639

(22) Filed: Apr. 25, 2018

(51) Int. Cl. G01C 21/16; G01P 7/00; G01P 15/18

(52) U.S. Cl. CPC G01C 21/16; G01P 15/18; G01P 7/00

(57) ABSTRACT

In an embodiment of the disclosed principles, a strap down integration (SDI) system includes a gyroscope that provides gyroscope data samples and an accelerometer that provides accelerometer data samples. A timing capture module associates a timestamp in a common time-base to data samples, and an SDI module linked to the timing capture module processes the timestamped data samples to produce orientation and velocity increments. In an embodiment, the SDI system also includes a priority buffer for storing the data stream produced by the timing capture module prior to provision of the data stream to the SDI module. The SDI module may output SDI motion increments at a time specified in an output request via an output request sample placed in the incoming data stream and having a timestamp in the common time-base.

### TECHNICAL FIELD

The present disclosure is related generally to motion tracking and, more particularly, in an embodiment of the described principles, to a system and method for processing 3D gyroscope data and 3D accelerometer data via strap-down integration (SDI).

### BACKGROUND

High-grade inertial measurement units (IMUs) typically employ numerical SDI of inertial data, e.g., angular velocity and linear acceleration, to produce orientation and velocity output increments. In such systems, the 3D accelerometer and 3D gyroscope are typically sampled synchronously in time at a very high rate, e.g. on the order of 1 kHz or more. Further, such systems typically reduce the SDI output rate by integrating a pre-determined number of samples in a time window. This produces a synchronous output data stream at the desired rate.

In an effort to address some limitations of standard SDI systems, U.S. Pat. No. 8,952,785 discloses a method and system to allow a master unit in communication with a sensing unit request motion data at variable output time intervals. In this way, the SDI output data intervals are not fixed, but may be a variable integer multiple of the SDI input samples period.

However, both standard SDI algorithms and the variation used in U.S. Pat. No. 8,952,785 assume that data related to physical motion on each of the three gyroscope and accelerometer channels is sampled at exactly the same time. When this condition is not met, significant performance degradation occurs. Although the sampling process for individual analog sensor components may be accurately controlled, the same is generally not possible when using discrete digital sensor components.

Before proceeding, it should be appreciated that the present disclosure is directed to a system that may address some of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

In an embodiment of the disclosed principles, a SDI system includes a gyroscope that provides gyroscope data samples via a gyroscope channel and an accelerometer that provides accelerometer data samples via an accelerometer channel. The gyroscope may be a 3D gyroscope, with the gyroscope channel serving 3D data, or may be a collection of single axis gyroscopes, with the gyroscope channel correspondingly including multiple separate data channels. A timing capture module linked to the gyroscope channel and the accelerometer channel associates a timestamp in a common time-base to asynchronous gyroscope data samples and accelerometer data samples received via the gyroscope channel and the accelerometer channel, and an SDI module linked to the timing capture module that processes the timestamped data samples, e.g., in chronological order. In an embodiment, the SDI system also includes a priority buffer for storing the data stream produced by the timing capture module prior to provision of the data stream to the SDI module.

The SDI module may be updated upon receiving each new input data sample, and the SDI module may output SDI motion increments at a time specified in an output request. In an embodiment, the output request is transferred to the SDI module via an output request sample placed in the incoming data stream and having a timestamp in the common time-base. The output request sample may cause the SDI module to further integrate the sensor data up to the timestamp of the output request sample and output the integrated motion increments.

Other features and aspects of the disclosed principles will be apparent from the detailed description taken in conjunction with the included figures, of which:

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic representation in keeping with an embodiment of the disclosed principles;

FIG. 2 is a simplified plot showing an architectural representation of an asynchronous SDI system in keeping with an embodiment of the disclosed principles;

FIG. 3 is a schematic diagram of a system in keeping with an embodiment of the disclosed principles wherein different host applications are served by the asynchronous SDI system;

FIG. 4 is a flowchart showing a process of producing velocity and orientation increments up to the request data update timestamp in accordance with an embodiment of the described principles; and

FIG. 5 is a flowchart showing a process of producing velocity and orientation increments at the time of a generated output data update event in accordance with an embodiment of the described principles.

### DETAILED DESCRIPTION

As noted above, current SDI systems face a number of challenges with respect to producing accurate information. For example, it may be desired to use an integrated 3D digital accelerometer, together with a different 3D digital gyroscope. In an instance of this situation, one or more analog gyroscopes are synchronously sampled by controlling the sample timing. However, these readings will still need to be further aligned to perform SDI of asynchronous accelerometer samples derived, for example, from a digital accelerometer.

Similarly, it may be desired to integrate multiple discrete single axis digital accelerometers and gyroscopes, or it may be desired to integrate multiple 3D digital sensors and for example use only one axis (e.g. the one providing best performance) per sensor, to exploit redundancy and achieve superior level of accuracy. Such discrete digital sensing components typically have a free-running internal clock which controls the sampling process. These clocks have variations in actual oscillation frequency with respect to nominal, ranging from a few ppm, up to several percent, depending on quality. Therefore, when combining together digital components with free-running clocks, the output samples are inherently not aligned in time. That is to say, output samples are provided in an asynchronous way to the SDI algorithm for further processing, leading to inaccuracy.

After the inertial data are processed by typical SDI algorithms, it is common to combine the orientation and velocity output increments in sensor fusion frameworks, together with diverse aiding data from other external systems, such as (RTK-) GNSS, magnetometer, camera, LIDAR, radar, or ultra-wideband radio. Proper sensor fusion, however, generally requires accurate synchronization of the SDI output increments with the external aiding data, in order to provide ideal performance. Standard SDI algorithms produce an output at a fixed rate which is a divisor of the input sensor sample rate, whether or not a data update is actually required for sensor fusion.

As such, it is generally not possible to accurately synchronize the SDI output with the external data. The U.S. Pat. No. 8,952,785 provides a possible solution to this by allowing a master unit to request data at any time. However the algorithm only produces output motion increments aligned with input SDI sampling rate. Therefore, time synchronization to less than one input sample period cannot be achieved.

Additionally, it is not possible in prior systems to adequately support different host applications. For example, in an illustrative embodiment it may be relevant to have SDI output from the same inertial data offered to both a first application at first time intervals (e.g. for sensor fusion with GNSS for navigation purposes), and to a second application at second, different time intervals (e.g. for sensor fusion with camera data to support computer vision algorithms for autonomous driving, or simply for signal monitoring). None of prior art methods would enable such functionalities.

In an embodiment of the disclosed principles, 3D gyroscope data and 3D accelerometer data are processed via SDI algorithms to provide orientation and velocity increments at arbitrary times. The disclosed principles further enable accurate numerical integration of input data when data samples from different sensing channels are not synchronous in time.

In a further embodiment, the disclosed principles additionally allow the provision of SDI-processed inertial data to different (asynchronous) host applications. In this way, accurate sensor fusion applications are enabled in a diversity of scenarios, e.g. when using discrete digital inertial sensor components typically having different internal free-running clocks, or when SDI processed inertial data need to be precisely synchronized with one or more external devices or host applications having different timing.

With this overview in mind, we turn now to a more detailed discussion of the disclosed principles in conjunction with the attached figures. The disclosed methods and systems allow for use of non-synchronous input samples (i.e. samples coming from different sensing channels that are not aligned in time). The latter benefit enables the use of discrete single or multi axis digital sensor components each with free-running internal clock (with the same or different nominal value of sampling rate) and the handling of arbitrary known delay in individual channels. In this way, components with different nominal value of latencies, for example, can be seamlessly integrated together.

For purposes of illustration, assume a scenario in which data from accelerometer and gyroscope channels may be generally sampled asynchronously. In the most general case, each individual gyroscope and accelerometer channel may be sampled independently, based on its free-running clock. Each clock may exhibit stochastic variations with respect to a nominal value. In addition, the nominal value of the sampling frequency for each channel may be the same or may be different.

In an exemplary implementation of the asynchronous SDI system disclosed herein, a core algorithm may use SDI equations to perform numerical integration. To handle asynchronous arrival of samples from each channel, one of the channels may be used as reference time-base for defining intervals in which SDI orientation and velocity increments are calculated. A per-channel interpolation algorithm may be used to reconstruct sensor data for all other channels, at the arrival times of samples on the reference channel. The interpolation algorithm may need to reconstruct the signal with relatively high precision, to preserve numerical accuracy. This requirement may demand for using relatively high order of interpolation, at potential cost of increased computational resources.

In an alternative implementation, the core asynchronous SDI algorithm may still use SDI equations to perform numerical integration. However, to handle asynchronous input data, the calculation of orientation and velocity increments may be updated at each new data sample arrival (e.g. upon arrival of a new sample from a single sensing channel). An extrapolation algorithm may be further used to reconstruct samples for the other channels with no new data, at the time of arrival of the new data sample.

In applications in which inertial sensors are sampled at a sufficiently high rate, a piecewise constant approximation may be used. In this implementation, it may be sufficient to hold only the latest accelerometer and gyroscope samples per each channel in a data buffer by the algorithm, together with storing the last update time of the SDI algorithm in cache. Such buffered data samples may be used for all subsequent calculations of orientation and velocity increments triggered by the arrival of new data samples on other channels, before being replaced in the data buffer by a new data sample from same channel. In applications in which higher accuracy is desired, a similar scheme could be implemented, but using a higher order polynomial for extrapolation and/or interpolation, at the cost of increased complexity and the need for a larger data buffer.

For the example implementations described above, data from the sensor channel with largest nominal frequency may be considered as reference data to take advantage of the greater sample resolution and improve SDI numerical accuracy.

For the example implementations described above, it may be beneficial to provide sample data in strictly chronological order with accurate timestamps in a common time-base. The timestamps can be used by the SDI numerical algorithm to determine the time interval in which integration will be performed. While sample timestamps may be generated by controlling sample timing explicitly in some applications, this option may be unavailable in other applications, e.g., when using digital sensors developed for consumer grade applications.

In an implementation of the disclosed principles, a timing capture module may be implemented on the processor running the SDI algorithms discussed above. The timing capture module may be used to capture the timing of, for example, a “data-ready” interrupt signal from each of the digital sensors. In an alternative embodiment, the timing capture module may determine the timestamp of each new sample by reading at sufficiently high rate the digital sensor output data register, optionally in combination with further extrapolation and/or estimation algorithms. It is also considered that the timestamp for accelerometer samples may be determined based on the gyroscope sample timing, alternatively to or in combination therewith, as discussed above.

In an alternative embodiment, sensor components of different types are integrated together. For example, in one implementation analog gyroscopes are integrated together with digital accelerometers. In this exemplary implementation, data from gyroscopes could be sampled synchronously with precise time reference by a processor, whereas samples from the digital accelerometer would be generally asynchronous. In this scenario, the timing capture module may be used to associate timestamps in the time-base generated by the processor solely to the accelerometer data samples. The timestamps may be used to determine the accelerometer values corresponding to the synchronous gyroscopes samples time instances. The latter may be achieved via interpolation or extrapolation schemes, similarly as discussed in previous sections. The determined accelerometer values, together with the gyroscope samples, may then be used by the SDI module to accurately calculate orientation and velocity increments. It will be appreciated that other variations of this optional implementation are possible.

In a further embodiment, for example in which low-power communication and/or processing may be desired, data from the digital sensors may be stored in their respective FIFO buffers before being transmitted to the application (e.g. upon occurrence of FIFO full) and being processed by the asynchronous SDI. The timing capture module may be used in this case to capture timing of only specific events or data samples. For example, in one implementation, the timing capture module may only capture the timing of an interrupt signal corresponding to occurrence of FIFO full event. The FIFO full event and interrupt signals may have known time relationship compared to sampling of last sample before FIFO full event. In a similar implementation, the interrupt event may be triggered directly by sampling of last sample before FIFO full event. In these exemplary scenarios, the timestamp of other samples in the FIFO may be further reconstructed by the processor implementing the timing capture module. For example, in one implementation this may be achieved by e.g. using knowledge of timestamp corresponding to multiple interrupt signals occurring upon consecutive FIFO full events. Other possible implementations and alternatives may be possible using similar concepts as those exemplary described.

It is observed that within these methods, other types of additional deterministic delay (e.g. latency introduced by multiplexed ADC, group-delay of low-pass filtering, etc.), if known, can be compensated for by modifying the captured sample timestamp. Specifications about such additional deterministic delays may either be known, as e.g. provided by the sensor component manufacturer, or further determined by dedicated routines. The latter could, for example, be based on applying physical motion which activates relevant channels (e.g. performed at time of calibration of the overall system), or may be based on using self-test functionality, often available in MEMS-based inertial sensors, providing signals for electromechanical actuation of the sensor itself.

To provide data samples in strictly chronological order, as is contemplated but not required, a sample is released for processing by the asynchronous SDI system typically once all older samples have been processed. This may be further complicated because sensor data is often fetched using a shared data bus, and that bus arbitration may not be guaranteed to be ordered. Furthermore, it is common for sensors to introduce different latencies with respect to the occurrence of actual physical events (e.g. caused by different low-pass filtering). In some embodiments, some or all such different latencies may be compensated for, before providing samples in the desired chronological order.

Timestamped samples from sensors may be ordered using a priority buffer, or other data structure with ordering condition, based on the timestamp. In some examples, a sample release logic unit may be included which allows sample data to be processed once, typically after previous expected samples have been released. Release logic implementations may vary, but in some cases no sample will be released for processing until all older samples have been processed. A practical example would be to delay sample release until the earliest expected time of the next sample has passed.

As noted above, there may be an arbitrary SDI output request time. The previous paragraphs have described various solutions directed to the limitation of asynchronous input data. The following discussion will be directed towards how to provide SDI motion increments at output at an arbitrary time, i.e. not necessarily aligned with input data samples.

In one embodiment, the decoupling of the timing between SDI output providing integrated orientation and velocity increments, and the gyroscope and accelerometer input data samples, may be accomplished by the inclusion of output request samples in the input data stream. Output request samples typically have a timestamp and possibly a data type, but no necessarily data. Processing of an output request sample by the asynchronous SDI algorithm provides an estimate of orientation and velocity increments at the timestamp of the output sample. It is noted that in some examples, the output sample timestamp may have greater precision than any sample clock, therefore such examples support output synchronization to an arbitrary resolution.

In some embodiments described in the previous section, in which the SDI is updated upon arrival of each new sample per channel, the processing of an output request sample may be accomplished by further integrating the orientation and velocity increments between time of last SDI update and the timestamp of the output request sample. In one implementation, such integration may be performed in a similar way to that described in previous paragraphs, for example, by relying on a piecewise constant or higher order polynomial signal assumption to extrapolate signals at desired timestamp. The available samples as stored in data buffer may be sufficient for this purpose, and the SDI output request at an arbitrary time can be handled seamlessly with the described architecture.

In other applications where some degree of increased latency may be acceptable, interpolation may be used instead of or in combination with extrapolation, thus providing generally superior accuracy. In other implementations, the SDI process using extrapolation may be further corrected upon arrival of new samples in time to accommodate high accuracy requirements with minimal latency, e.g., by means of interpolation using such new samples in time to reconstruct signals more accurately. In this way, extrapolation used to provide output data at the desired request time will typically result in momentary, minor fluctuations in integral value provided at output, which errors would not accumulate over time.

It is noted that timestamps of output request samples may share the same time-base as the timestamps of input data samples. In one exemplary scenario, timing requests for output samples may be controlled by the processor controlling the SDI algorithm (e.g. because of need to provide SDI output data based on reference clock of such processor). In another exemplary scenario, output request samples may be triggered by the arrival of new data from possible external sensors typically connected to the same processor, or by external applications running on a host platform different from the processor implementing the asynchronous SDI methods here described. In these latter cases, the same processor controlling the asynchronous SDI process may attach timestamps upon receiving output requests, using similar timing capture module as described in previous sections.

As noted above, the handling of multiple host applications may create difficulties in ordinary SDI implementations. However, the asynchronous SDI system here described will produce orientation and velocity increments related to an initial start time per definition. In one embodiment, the asynchronous SDI integration process may be reset upon processing of an output request sample. In this way, each SDI output would directly contain orientation and velocity increments corresponding to the time interval between two output request samples, as specified by their corresponding timestamps.

In some embodiments, the methods disclosed herein are combined further with some aspects of U.S. Pat. No. 9,526,028, issued Dec. 16, 2016, assigned to the same. In this case, the SDI integration process may not be reset upon processing of an output request sample, which means that the orientation and velocity increments provided at SDI output may be calculated with respect to a fixed, initial integration start time. When further combined with an inertial differentiator at the host side, as disclosed in U.S. Pat. No. 9,526,028, issued Dec. 20, 2016, the velocity and orientation increments corresponding to each update request time interval may be reconstructed at the application side.

One benefit of such an embodiment is that the overall integration process may not be affected by output request samples. The latter may result in additional time instants in which the numerical integrals are evaluated, but the same integration process may continue unaffected upon receiving new sensor data samples. In this way, it becomes possible to seamlessly support multiple applications, each possibly having its own (asynchronous) request for output samples. This feature is especially enabling when it may be desired to use SDI-processed inertial data to serve diverse sensor fusion applications.

Considering automotive applications for the sake of example, data from the same inertial sensors may be used both for sensor fusion with a magnetometer and/or GNSS for orientation and position tracking, as well as for sensor fusion with, for example, LIDAR and camera to serve advanced driver-assistance systems (ADAS) applications. The latter may utilize the same SDI processed data at diverse time instants compared to orientation and position tracking, since the processing may be implemented on a different host processor with a different time-base.

It is worth noting that, although all previous paragraphs have used the exemplary case of SDI processing of accelerometer and gyroscope input data to provide at output velocity and orientation increments, the same principles may be applied to the SDI of 3D gyroscope data only, providing orientation increments at output. The disclosure applied to this scenario would provide similar benefits as discussed in detail in previous sections.

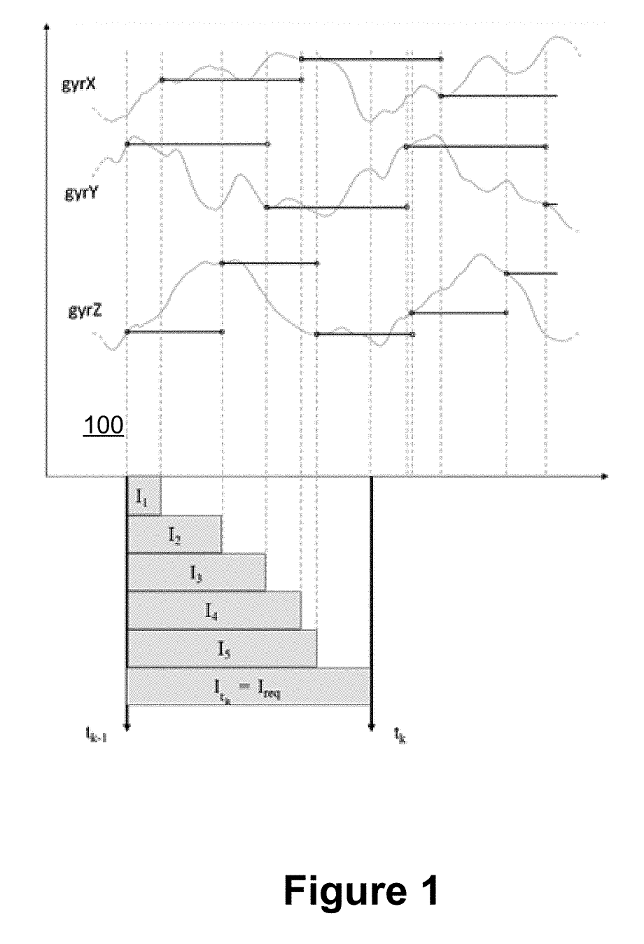

Turing more specifically to the figures, FIG. 1 is a schematic representation in keeping with an embodiment of the disclosed principles. In the illustrated example 100, three gyroscope channels are integrated over the time interval between two data output requests at times tₖ₋₁ and tₖ, respectively, to produce an orientation output increment Iₜ_{ₖ} at time tₖ. The SDI process is updated upon receiving each new (asynchronous) data sample, by calculating the incremental integral quantities I₁, . . . I_{S}. The SDI process is further updated upon receiving the data output request at the time instant tₖ, by calculating a further incremental quantity Iₜ_{ₖ}=I_{req}. The overall SDI motion increment Iₜ_{ₖ} is then provided at output.

It should be noted, as was stated above in overview, the 3D gyroscope may be a single integrated 3D gyroscope, with the gyroscope channel serving 3D data. Alternatively, the 3D gyroscope may comprise a collection of three (3) single axis gyroscopes, with the gyroscope channel correspondingly including three (3) separate data channels.

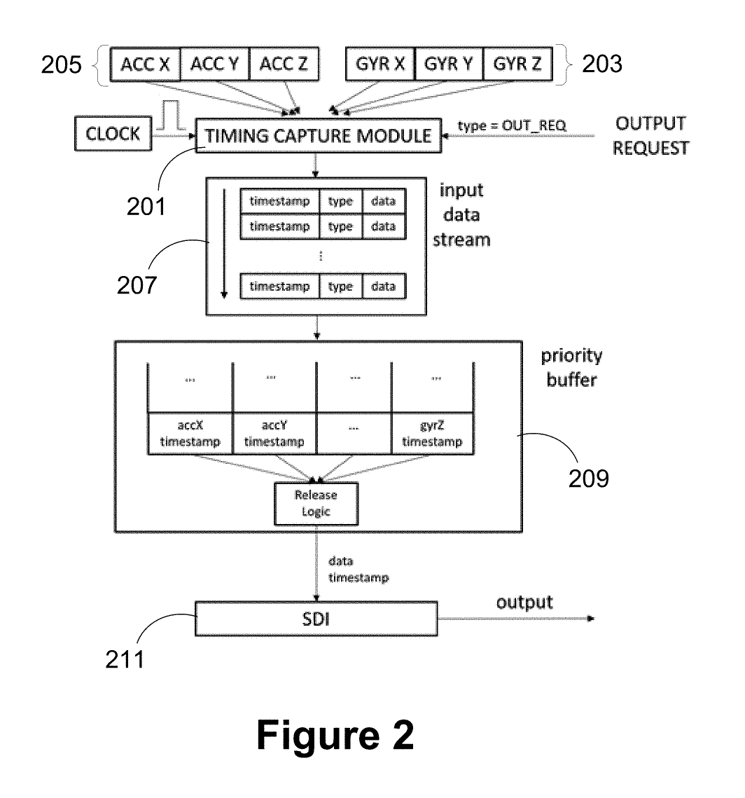

Turing to FIG. 2 a simplified plot of an architectural representation of an asynchronous SDI system is shown in keeping with an embodiment of the disclosed principles. In this example, a timing capture module 201 associates a timestamp in a common time-base to asynchronous samples 203, 205 received from gyroscope and accelerometer channels respectively. The resulting input data stream 207 is stored in a priority buffer 209.

The SDI module 211 processes the data samples in typically a chronological order. The SDI module 211 may be updated upon receiving each new input data sample. Output SDI motion increments at desired (arbitrary) time corresponding to an output request are enabled by inserting in the input data stream 207 output request samples. Output request samples have a timestamp (in the same time-base as sensor data timestamps), but not necessarily actual data. Processing of an output request sample by the SDI module 211 may result in further integrating the sensor data up to the timestamp of the output request sample and providing the integrated motion increments at output.

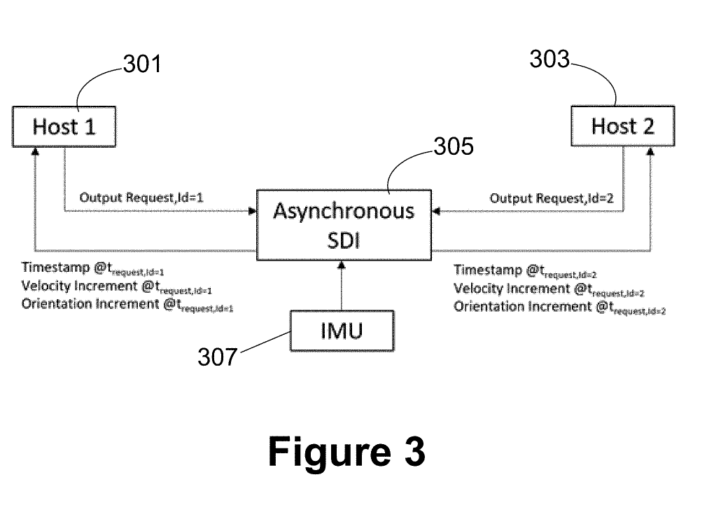

FIG. 3 shows an embodiment of the described principles wherein different host applications 301, 303 are served by the same asynchronous SDI module 305. Each host application 301, 303 sends a data output request to the asynchronous SDI module 305. The asynchronous SDI module 305 determines a timestamp of each output request in its time-base, integrates data from the IMU 307 up to the time of the output request, and provides at output orientation increments, velocity increments and timestamp data associated with the data output request.

To allow the serving multiple applications, the integration process is not reset after processing an output request; instead, orientation and velocity increments provided at the SDI output are typically calculated with respect to a fixed, initial integration start time. The actual orientation and velocity increments corresponding to time intervals in between output requests can then be reconstructed at the host side.

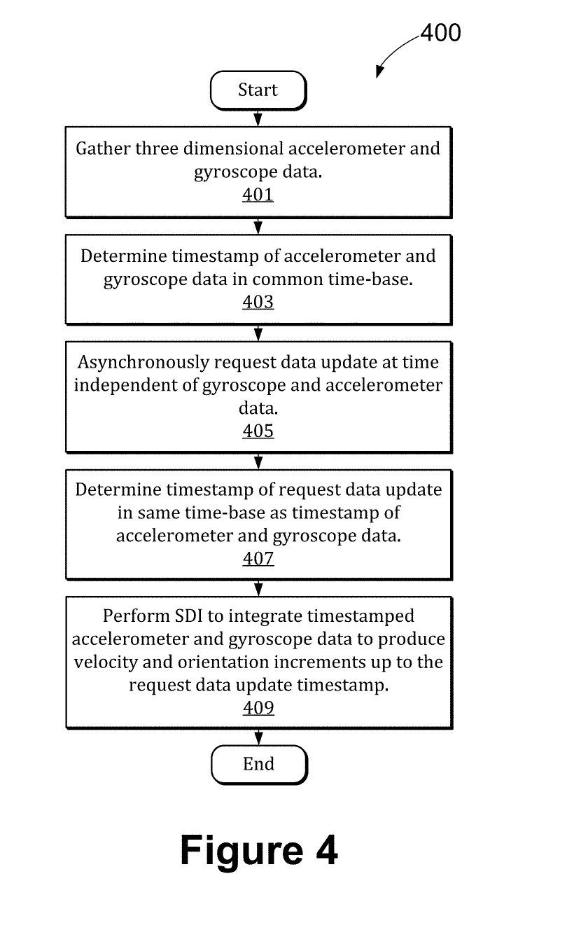

FIG. 4 is a flowchart showing a process of producing velocity and orientation increments up to the request data update timestamp in accordance with an embodiment of the described principles. At stage 401 of the process 400, three dimensional accelerometer and gyroscope data is gathered, and the timestamp of accelerometer and gyroscope data are determined in a common time-base at stage 403.

At stage 405, a data update is asynchronously requested at a time independent of the actual gyroscope and accelerometer data, and at stage 407, the timestamp of the request data update is determined in the same time-base as the timestamp of the accelerometer and gyroscope data. Finally, SDI is performed at stage 409 to integrate timestamped accelerometer and gyroscope data to produce velocity and orientation increments up to the request data update timestamp.

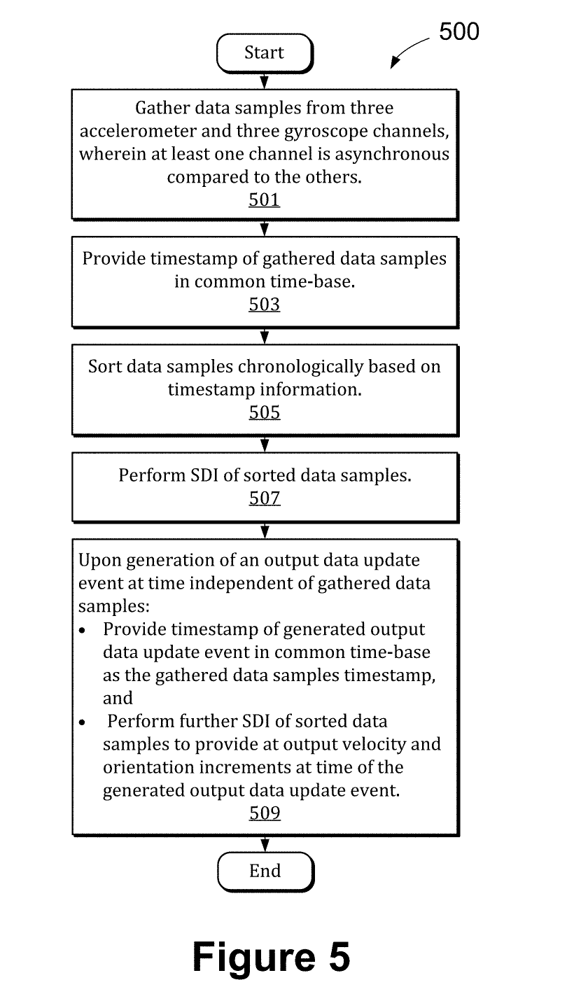

FIG. 5 is a flowchart showing a process of producing velocity and orientation increments at the time of a generated output data update event in accordance with an embodiment of the described principles. At stage 501, data samples are gathered from three accelerometer and three gyroscope channels, with at least one channel being asynchronous to the others. The gathered data samples are timestamped in a common time-base at stage 503. After sorting the data samples chronologically based on timestamp information at stage 505, SDI is performed at stage 507 on the sorted data samples.

In stage 509, upon generation of an output data update event at a time independent of the gathered data samples, a timestamp of generated output data update event is provided in a common time-base with the gathered data samples' timestamp, and further SDI of sorted data samples is performed to output velocity and orientation increments at the time of the generated output data update event.

In a further embodiment, a strap down integration (SDI) system is provided having a three-dimensional (3D) accelerometer providing 3D accelerometer data samples via an accelerometer channel, a 3D gyroscope providing 3D gyroscope data samples via a gyroscope channel, a timing capture module linked to the accelerometer channel that associates a timestamp in a common time-base to asynchronous accelerometer data samples received in the accelerometer channel, and an SDI module linked to the timing capture module that processes the 3D gyroscope data samples and the 3D accelerometer data samples that are associated with timestamps in the common time-base to produce orientation and velocity increments, in response to output timestamps in the common time-base.

The SDI system in accordance with the further embodiment may update the SDI module upon receiving each new input data sample, and further, the

20. The SDI system in accordance with claim 18, wherein the SDI module outputs SDI motion increments at a time specified in an output request.

21. The SDI system in accordance with claim 20, wherein the output request is transferred to the SDI module via an output request sample in the incoming data stream.

22. The SDI system in accordance with claim 21, wherein the output request sample has a timestamp in the common time-base.

23. The SDI system in accordance with claim 20, wherein the SDI module is configured to process an output request sample by further integrating the accelerometer data up to the timestamp of the output request sample and outputting the integrated motion increments.

30. A strap down integration (SDI) system comprising:
a three-dimensional (3D) gyroscope providing asynchronous 3D gyroscope data samples via a gyroscope channel;
a timing capture module linked to the gyroscope channel configured to receive an asynchronous request for SDI data and to associate a timestamp to the 3D gyroscope data samples; and
a SDI module linked to the timing capture module and configured to process the timestamped data samples to produce orientation increments.

31. A strap down integration (SDI) system comprising:
a three-dimensional (3D) accelerometer providing 3D accelerometer data samples via an accelerometer channel;
a 3D gyroscope providing 3D gyroscope data samples via a gyroscope channel;
a timing capture module linked to the gyroscope channel that associates a timestamp in a common time-base to asynchronous gyroscope data samples received in the gyroscope channel; and
an SDI module linked to the timing capture module that processes the accelerometer data and timestamped gyroscope data samples to produce orientation and velocity increments.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof

We claim:

1. A strap down integration (SDI) system comprising:
a three-dimensional (3D) gyroscope configured to provide 3D gyroscope data samples via a gyroscope channel;
a 3D accelerometer configured to provide 3D accelerometer data samples via an accelerometer channel;
a timing capture module coupled to the gyroscope channel and the accelerometer channel, that is configured to associate a timestamp in a common time-base to the 3D gyroscope data samples and the 3D accelerometer data samples received from the gyroscope channel and the accelerometer channel; and
an SDI module coupled to the timing capture module that is configured to process 3D gyroscope data samples and 3D accelerometer data samples that are respectively associated with common timestamps from the common time-base to generate orientation and velocity increments.

2. The SDI system in accordance with claim 1, further comprising a FIFO buffer configured to store data samples and provide them to the timing capture module.

3. The SDI system in accordance with claim 1, wherein the 3D gyroscope is a single unit and the gyroscope channel comprises a single channel.

4. The SDI system in accordance with claim 1, wherein the 3D gyroscope comprises at least three single axis gyroscopes and wherein the gyroscope channel comprises three respective channels.

5. The SDI system in accordance with claim 1, wherein the 3D accelerometer is a single unit and the accelerometer channel comprises a single channel.

6. The SDI system in accordance with claim 1, wherein the 3D gyroscope comprises multiple discrete multi-axis gyroscopes and wherein the gyroscope channel comprises three channels, and each of the three channels gathers data from a respective axis of the multiple discrete multi-axis gyroscopes.

7. The SDI system in accordance with claim 1, wherein the 3D accelerometer comprises multiple discrete multi-axis accelerometers and wherein the accelerometer channel comprises three channels, and each of the three channels gathers data from a respective axis of the multiple discrete multi-axis accelerometers.

8. The SDI system in accordance with claim 1, wherein the 3D accelerometer is a collection of three single axis accelerometers and wherein the accelerometer channel comprises three respective channels.

9. The SDI system in accordance with claim 1, wherein at least one of the accelerometer channel and the gyroscope channel comprises multiple channels, and data from the multiple channels are asynchronous.

10. The SDI system in accordance with claim 1, further comprising a priority buffer for storing the data stream produced by the timing capture module prior to provision of the data stream to the SDI module.

11. The SDI system in accordance with claim 1, wherein the SDI module is reinitiated upon receiving each new input data sample.

12. The SDI system in accordance with claim 1, wherein the SDI module is further configured to use one of interpolation of and extrapolation of the data samples prior to generating orientation and velocity increments.

13. The SDI system in accordance with claim 1, wherein the SDI module outputs SDI motion increments at a time specified in an output request received by the SDI module.

14. The SDI system in accordance with claim 13, wherein the output request is transferred to the SDI module via an output request sample in an incoming data stream.

15. The SDI system in accordance with claim 14, wherein the output request sample has a timestamp in the common time-base.

16. The SDI system in accordance with claim 13, wherein the SDI module is configured to process an output request sample by further integrating the sensor data up to the timestamp of the output request sample and outputting the integrated motion increments.

17. The SDI system in accordance with claim 1, wherein the 3D gyroscope data samples from the 3D gyroscope and the 3D accelerometer data samples from the 3D accelerometer are asynchronous.

18. A strap down integration (SDI) system comprising:
a three-dimensional (3D) accelerometer providing 3D accelerometer data samples via an accelerometer channel;
a 3D gyroscope providing 3D gyroscope data samples via a gyroscope channel;
a timing capture module linked to the gyroscope channel and to the accelerometer channel configured to receive an asynchronous request for SDI data and to associate a timestamp in a common time-base to the request; and
an SDI module linked to the timing capture module that processes the data samples to produce orientation and velocity increments, the SDI module being further configured to calculate orientation and velocity increments up to the time of the asynchronous request.

19. The SDI system in accordance with claim 18, wherein the SDI module is further configured to interface with multiple host applications.

20. The SDI system in accordance with claim 18 wherein, the 3D gyroscope data samples are synchronous with the 3D accelerometer data samples.

21. The SDI system in accordance with claim 18, wherein the timing capture module further associates a timestamp in the common time-base to the 3D gyroscope data samples and the 3D accelerometer data samples.

22. The SDI system in accordance with claim 18 wherein the SDI process is reset after calculating orientation and velocity increments up to the time of the request.

23. The SDI system in accordance with claim 18 wherein the orientation and velocity increments are calculated with respect to a fixed initial time.

24. A method of generating orientation and velocity increments via strap down integration (SDI), the method comprising:
collecting three-dimensional (3D) accelerometer data samples;
collecting 3D gyroscope data samples;
receiving an asynchronous request for SDI data and associating a timestamp in a common time-base to the request; and
processing the data samples to produce orientation and velocity increments.

25. The method in accordance with claim 24, wherein processing the data samples further comprises calculating orientation and velocity increments up to the time of the asynchronous request.

26. The method in accordance with claim 24, further comprising associating a timestamp in the common time-base to the 3D gyroscope data samples and the 3D accelerometer data samples.
